(19) United States
(12) Patent Application Publication
(10) Pub. No.: US 2016/0224330 A1
(43) Pub. Date: Aug. 4, 2016

(54) METHOD AND SYSTEM FOR SYNCHRONOUSLY UPDATING PROGRAMS OF INTELLIGENT APPARATUSES

(71) Applicant: GEMTEK TECHNOLOGY CO., LTD., Hsinchu (TW)

(72) Inventor: CHUNG-CHIU LAI, Hsinchu (TW)

(21) Appl. No.: 14/660,785

(22) Filed: Mar. 17, 2015

(30) Foreign Application Priority Data
Jan. 29, 2015 (CN) 201510045466.8

(51) Int. Cl. G06F 9/445; H04L 29/08; H04W 84/12

(52) U.S. Cl. CPC G06F 8/65; H04W 84/12; H04L 67/34; H04L 67/1095

(57) ABSTRACT

A method and system for synchronously updating programs of intelligent apparatuses are described. A host unit activates rapid update device mechanism. A plurality of first intelligent apparatuses search the host unit wherein each first intelligent apparatus returns its device information to host unit. The host unit transmits connection configuration information to at least one first intelligent apparatus for establishing the communication connection between the at least one first intelligent apparatus and server. The host unit sends updating instructions to first intelligent apparatus to notify the at least one first intelligent apparatus of the program updated procedure. The at least one first intelligent apparatus downloads the updating programs from the server based on the updating instructions of the host unit. The present invention is capable of rapidly and synchronously updating the programs of intelligent apparatuses to simplify the program updated and/or configured procedure.

### BACKGROUND OF THE INVENTION

1. Field of Invention

The present invention relates to a updating method and system thereof, and more particularly relates to a method and system for synchronously updating the programs of intelligent apparatuses.

2. Description of Prior Art

Network services may be provided by wireless connection without the network cables and thus many users gradually employ the wireless connection to access the network services. Moreover, with the rapid development of wireless network, the transmission rate provided by the wireless network becomes increasingly faster. Thus, many intelligent apparatuses, e.g. IP cameras and digital still cameras, or mobile devices, are capable of transmitting the data content by way of the wireless network but does not provide wired networking interface for the transmission. However, if a plurality of new intelligent apparatuses need to update and configure the programs simultaneously, it is merely performs a point-to-point operation of intelligent apparatuses wherein the server provides the program updating procedure for one intelligent apparatus at one time, which results in the inconvenience of the program updating procedure when the intelligent apparatuses are manufactured or maintained. Consequently, there is a need to develop a novel method and system to solve the problems of updating program of the intelligent apparatuses.

### SUMMARY OF THE INVENTION

One objective of the present invention is to provide a method and system for synchronously updating the programs of intelligent apparatuses wherein a host unit activates a rapid update device mechanism for synchronously and rapidly updating the programs of intelligent apparatuses to simplify the program configuration of the intelligent apparatuses and improve the manufacturing efficiency of the intelligent apparatuses.

According to the above objectives, a first embodiment of the present invention sets forth a method and system for synchronously updating the programs of intelligent apparatuses. The method for synchronously updating the programs of a plurality of intelligent apparatuses, comprising the steps of: activating a rapid update device mechanism by way of a host unit wherein the rapid update device mechanism comprises a service set identifier (SSID); searching the SSID of the host unit by way of the first intelligent apparatuses wherein device information of each first intelligent apparatus is returned to the host unit when each first intelligent apparatus detects the SSID; transmitting a connection configuration information to at least one first intelligent apparatus by way of the host unit for establishing communication connection between the at least one first intelligent apparatus and server wherein at least one updating program is stored in the server; sending a updating instruction to the at least one first intelligent apparatus to notify the at least one first intelligent apparatus of a program updated procedure by way of the host unit; and downloading the updating program from the server based on the updating instruction of the host unit by way of the at least one first intelligent apparatus.

In one embodiment, the connection configuration information is compatible to Wireless Fidelity (Wi-Fi) protocol which is established by a wireless network access point or a router.

In one embodiment, before the step of activating the rapid update device mechanism by way of the host unit, the method further comprises a step of assigning one of the first intelligent apparatuses as the host unit by way of a mobile device.

In one embodiment, after the step of sending the updating instruction to the at least one first intelligent apparatus to notify the at least one first intelligent apparatus of the program updated procedure by way of the host unit, the method further comprises a step of logging in the server and sending a download request to the server based on the connection configuration information by way of the at least one first intelligent apparatus.

In one embodiment, after the step of downloading the updating program from the server based on the updating instruction of the host unit, the method further comprises a step of returning a updating complete message of the at least one updating program to host unit by way of the at least one first intelligent apparatus.

In one embodiment, after the step of downloading the updating program from the server based on the updating instruction of the host unit, the method further comprises a step of detecting a updating complete message of the at least one updating program by way of the host unit wherein the at least one first intelligent apparatus broadcasts the updating complete message initially.

In one embodiment, after the step of activating the rapid update device mechanism by way of the host unit, the method further comprises a step of scanning the first intelligent apparatuses for acquiring the device information of the at least one first intelligent apparatus by way of the host unit.

In one embodiment, the host unit selects a part of the scanned first intelligent apparatuses.

In one embodiment, after the step of sending the updating instruction to the at least one first intelligent apparatus to notify the at least one first intelligent apparatus of the program updated procedure by way of the host unit, the method further comprises a step of logging in the server and sending a download request to the server based on the connection configuration information by way of the part of the scanned first intelligent apparatuses.

In one embodiment, after the step of downloading the updating program from the server based on the updating instruction of the host unit, the method further comprises a step of returning a updating complete message of the at least one updating program to the host unit by way of the part of the scanned first intelligent apparatuses.

In one embodiment, after the step of downloading the updating program from the server based on the updating instruction of the host unit, the method further comprises a step of detecting a plurality of updating complete messages of the at least one updating program by way of the host unit wherein the part of the scanned first intelligent apparatuses broadcast the updating complete messages initially.

In the present invention, the system for synchronously updating the programs of a plurality of intelligent apparatuses comprises a host unit, for activating a rapid update device mechanism wherein the rapid update device mechanism comprises a service set identifier (SSID); the first intelligent apparatuses, for searching the SSID of the host unit wherein device information of each first intelligent apparatus is returned to the host unit when each first intelligent apparatus detects the SSID, and the host unit transmits a connection configuration information to at least one first intelligent apparatus; and a server, for storing at least one updating program wherein the host unit establishes a communication connection between the at least one first intelligent apparatus and the server; wherein the host unit sends a updating instruction to the at least one first intelligent apparatus to notify the at least one first intelligent apparatus of a program updated procedure, and the at least one first intelligent apparatus downloads the updating program from the server based on the updating instruction of the host unit.

In one embodiment, the connection configuration information is compatible to Wireless Fidelity (Wi-Fi) protocol which is established by a wireless network access point or a router.

In one embodiment, the host unit is a transmitter with a wireless network function for sending the connection configuration information.

In one embodiment, the host unit is one selected from the first intelligent apparatuses and the selected first intelligent apparatus is initialized to be served as a second intelligent apparatus for transferring the connection configuration information.

In one embodiment, the system further comprises a mobile device for assigning one of the first intelligent apparatuses as the host unit.

In one embodiment, the at least one first intelligent apparatus logs in the server and sends a download request to the server based on the connection configuration information.

In one embodiment, the at least one first intelligent apparatus returns a updating complete message of the at least one updating program to host unit.

In one embodiment, the host unit detects a updating complete message of the at least one updating program and the at least one first intelligent apparatus broadcasts the updating complete message initially.

In one embodiment, the host unit scans the first intelligent apparatuses for acquiring the device information of the at least one first intelligent apparatus.

In one embodiment, the host unit selects a part of the scanned first intelligent apparatuses.

In one embodiment, the part of the scanned first intelligent apparatuses log in the server and send a download request to the server based on the connection configuration information.

In one embodiment, the part of the scanned first intelligent apparatuses return a updating complete message of the at least one updating program to the host unit.

In one embodiment, the host unit detects a plurality of updating complete messages of the at least one updating program and the part of the scanned first intelligent apparatuses broadcast the updating complete messages initially.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic block diagram of a system for synchronously updating the programs of a plurality of intelligent apparatuses according to a first embodiment of the present invention;

FIG. 2 is a schematic block diagram of a system for synchronously updating the programs of the intelligent apparatuses according to a second embodiment of the present invention;

FIG. 3 is a schematic signal flow diagram of synchronously updating the programs of the intelligent apparatuses according to the first embodiment of the present invention;

FIG. 4 is a schematic signal flow diagram of synchronously updating the programs of the intelligent apparatuses according to the second embodiment of the present invention;

FIG. 5 is a schematic flow chart of synchronously updating the programs of the intelligent apparatuses by way of the updating system according to the first embodiment of the present invention; and

FIG. 6 is a schematic flow chart of synchronously updating the programs of the intelligent apparatuses by way of the updating system according to the second embodiment of the present invention.

### DETAILED DESCRIPTION OF THE PREFERRED EMBODIMENTS

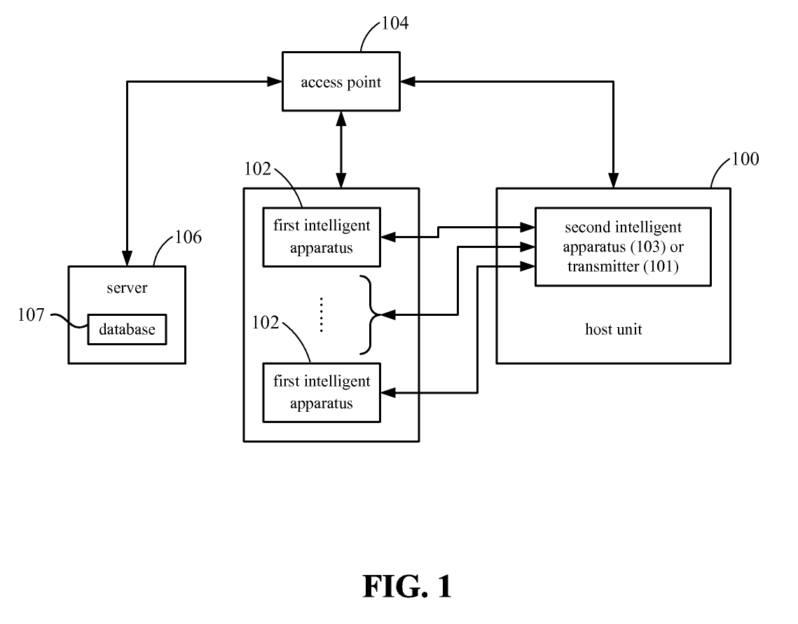

Referring to FIG. 1, it is a schematic block diagram of a system for synchronously updating the programs of a plurality of intelligent apparatuses according to a first embodiment of the present invention. The system comprises a host unit 100, a plurality of first intelligent apparatuses 102, an access point (AP) 104 and a server 106. The host unit 100 is coupled to the first intelligent apparatuses 102 and the AP 104. The first intelligent apparatuses 102 are coupled to the AP 104 respectively which is coupled to the server 106. The server 106 comprises a database 107. In one embodiment, the host unit 100 is coupled to each first intelligent apparatus 102 and the AP 104 by way of wireless connection. Each first intelligent apparatus 102 is coupled to the AP 104 by the wireless connection. The AP 104 is coupled to the server 106 by way of wired connection or wireless connection. In another embodiment, the host unit 100 is coupled to each first intelligent apparatus 102 by way of wireless connection and is coupled to the AP 104 and the server by way of wired connection respectively. In the system, regardless of each first intelligent apparatus 102 with either wired or wireless connection, each first intelligent apparatus 102 is coupled to the server 106 via the host unit 100 and the AP 104. In other words, the host unit 100 is capable of selecting one or more first intelligent apparatus 102 at one time and the selected first intelligent apparatuses 102 connect the server 106 via the AP 104 for performing a synchronous program updating procedure to simplify the program configuration of the first intelligent apparatuses 102 and thus improve the manufacturing efficiency of the first intelligent apparatuses 102.

The host unit 100 activates a rapid update device mechanism wherein the rapid update device mechanism comprises a service set identifier (SSID). For example, the host unit 100 transmits the SSID, which is provided to each the first intelligent apparatus 102 for identification, to an arrangement region of the first intelligent apparatuses 102. Each intelligent apparatus searches the SSID of the host unit 100. For example, when each the first intelligent apparatus 102 is powered on, it is capable of searching or finding whether the SSID exists on the air. The device information of each intelligent apparatus 102 is returned to the host unit 100 when each intelligent apparatus 102 detects the SSID. The server 106 stores at least one updating program in the database 107 wherein the at least one updating program is selected from one group consisting of updating parameters, software, application programs, drivers and the combination thereof. The host unit 100 transmits a connection configuration information to at least one intelligent apparatus 102 for establishing a communication connection between the at least one intelligent apparatus 102 and the server 106. In one embodiment, the connection configuration information is compatible to Wireless Fidelity (Wi-Fi) protocol which is established by a wireless network access point 104 or a router (not shown) so that the intelligent apparatus 102 logs in the server 106 after the intelligent apparatus 102 connects the AP 104 of the router.

In FIG. 1, the host unit 100 sends a updating instruction to the at least one intelligent apparatus 102 to notify the at least one intelligent apparatus 102 of a program updated procedure. In other words, the at least one intelligent apparatus 102 logs in the server 106 based on the connection configuration information and sends a download request to the server 106. The at least one intelligent apparatus 102 downloads the updating program from the server 106 based on the updating instruction of the host unit 100. In one embodiment, the at least one intelligent apparatus 102 returns a updating complete message of the at least one updating program to host unit 100 after the intelligent apparatus 102 downloads the updating program completely. In another embodiment, the host unit 100 detects a updating complete message of the at least one updating program and the at least one intelligent apparatus 102 broadcasts the updating complete message initially so that the host unit 100 receives the broadcasted updating complete message from the intelligent apparatus 102.

As shown in FIG. 1, the host unit 100 is a transmitter 101 with a wireless network function for sending the connection configuration information to intelligent apparatuses 102 wherein the rapid update device mechanism is embedded in the transmitter 101 according to one embodiment of the present invention. In another embodiment, the host unit 100 is one selected from the intelligent apparatuses 102 and the selected intelligent apparatus 102 is initialized to be served as a second intelligent apparatus 103 for transferring the connection configuration information to the intelligent apparatuses 102 wherein the rapid update device mechanism is embedded in the second intelligent apparatus 103 which is served with or without the function of access point.

Still in another embodiment, when the host unit 100 is coupled to each intelligent apparatuses 102 by wireless connection and the host unit 100 is integrated to the AP 104 so that the integration of host unit 100 and AP 104 is coupled to the server 106 by wired or wireless connection wherein the rapid update device mechanism is embedded in the integration of host unit 100 and AP 104.

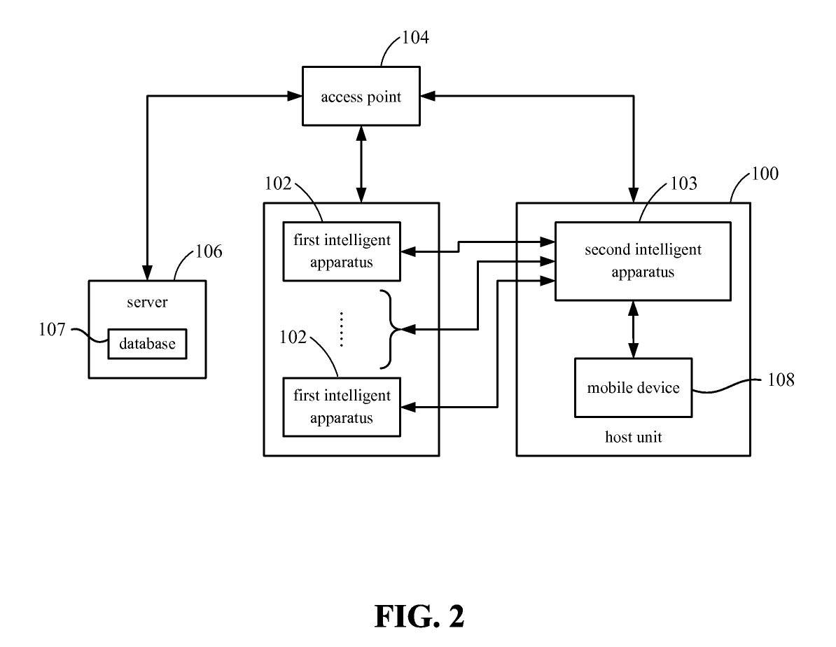

Referring to FIG. 2, it is a schematic block diagram of a system for synchronously updating the programs of a plurality of intelligent apparatuses according to a second embodiment of the present invention. The system for synchronously updating the programs of a plurality of intelligent apparatuses in FIG. 2 is similar to that in FIG. 1. The difference is that a mobile device 108 assigns one of the intelligent apparatuses 102 as a second intelligent apparatuses 103 of the host unit 100. In other words, the host unit 100 is composed of the mobile device 108 and the second intelligent apparatuses 103 coupled to the mobile device 108. In one case, the mobile device 108 is selected from one group consisting of mobile phone, notebook computer and tablet computer, but not limited. For example, the mobile device 108 is portable communication electronic device.

Please refer to FIG. 1 and FIG. 2 continuously. The host unit 100 scans the intelligent apparatuses 102 for acquiring the device information of the at least one intelligent apparatus 102 wherein the host unit 100 selects a part of the scanned intelligent apparatuses 102 or all the intelligent apparatuses 102. In this case, the host unit 100 selects the part of the scanned intelligent apparatuses 102. The part of the scanned intelligent apparatuses then log in the server 106 and send a download request to the server 106 based on the connection configuration information. The part of the scanned intelligent apparatuses 102 return a updating complete message of the at least one updating program to the host unit 100 after the intelligent apparatuses 102 downloads updating programs. The host unit 100 detects a plurality of updating complete messages of the at least one updating program and the part of the scanned intelligent apparatuses 102 broadcast the updating complete messages initially after the intelligent apparatuses 102 downloads updating programs so that the host unit 100 is able to receive the updating complete messages.

According to the aforementioned descriptions, the system for synchronously updating the programs of intelligent apparatuses employs a host unit 100 to manipulate a plurality of first intelligent apparatuses 102 to download the updating programs from the server 106 for updating the programs of the first intelligent apparatuses 102 synchronously and rapidly. In other words, the host unit 100 selects multiple first intelligent apparatuses 102 at one time and the selected first intelligent apparatuses 102 connects the server 106 via the AP 104 to synchronously implement program updating procedure for simplifying the program configuration of the intelligent apparatuses 102 and improve the manufacturing efficiency of the intelligent apparatuses 102.

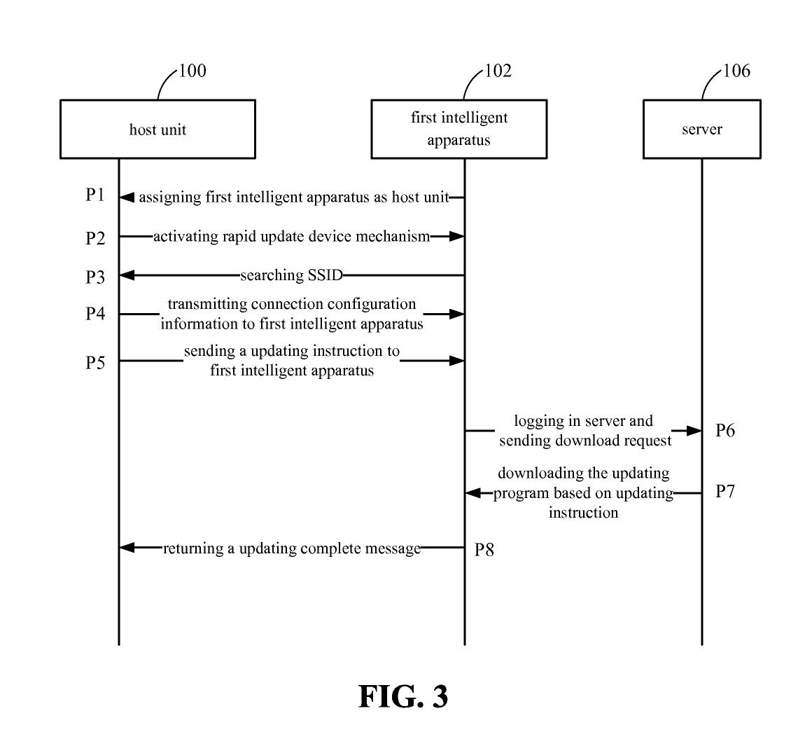

As shown in FIG. 1 through FIG. 3, FIG. 3 is a schematic signal flow diagram of synchronously updating the programs of the intelligent apparatuses according to the first embodiment of the present invention. In the signal flow P1, the system assigns an initialized first intelligent apparatus 102 as a second intelligent apparatus 103 of host unit 100, or assigns a transmitter 101 of host unit 100 as an information transmitting device. In the signal flow P2, the host unit 100 activates rapid update device mechanism. In the signal flow P3, the first intelligent apparatus 102 searches the SSID corresponding to rapid update device mechanism of the host unit 100. In the signal flow P4, the host unit 100 transmits connection configuration information associated with server 106 to first intelligent apparatus 102. In the signal flow P5, the host unit 100 sends a updating instruction corresponding to rapid update device mechanism to first intelligent apparatus 102. In the signal flow P6, the first intelligent apparatus 102 logs in the server 106 and sends a download request to the server 106 based on the connection configuration information. In the signal flow P7, the first intelligent apparatus 102 downloads the updating program based on updating instruction from the server 106. In the signal flow P8, the first intelligent apparatus 102 returns a updating complete message to the host unit 100.

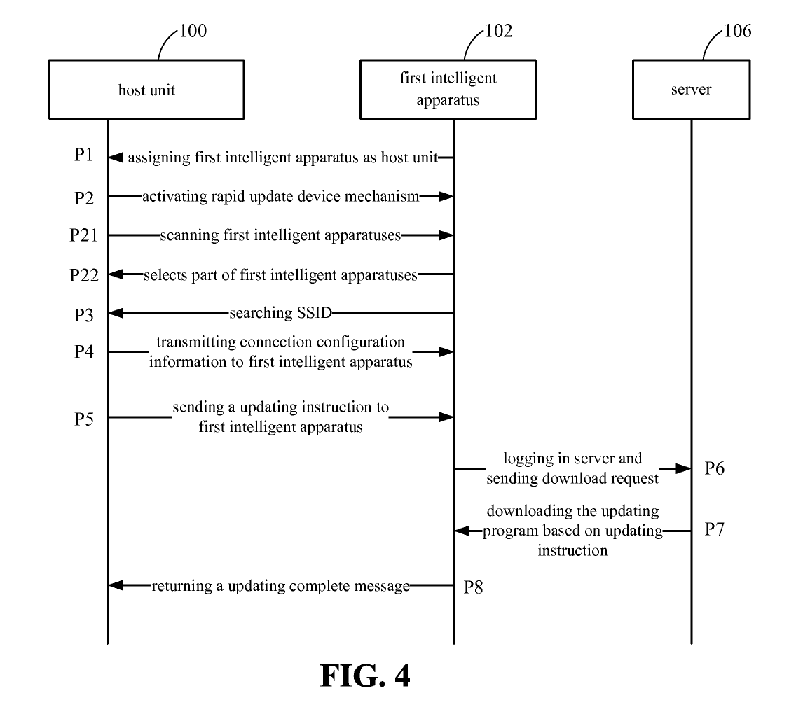

As shown in FIGS. 1, 2 and 4, FIG. 4 is a schematic signal flow diagram of synchronously updating the programs of the intelligent apparatuses according to the second embodiment of the present invention. In the signal flow P1, the system assigns an initialized first intelligent apparatus 102 as a second intelligent apparatus 103 of host unit 100, or assigns a transmitter 101 of host unit 100 as an information transmitting device. In the signal flow P2, the host unit 100 activates the rapid update device mechanism. In the signal flow P21, the host unit 100 scans the first intelligent apparatuses 102 to compute the amount of the first intelligent apparatuses 102. In the signal flow P22, the host unit 100 selects a part of the scanned first intelligent apparatuses 102. In the signal flow P3, the selected first intelligent apparatus 102 searches the SSID corresponding to rapid update device mechanism of the host unit 100. In the signal flow P4, the host unit 100 transmits connection configuration information associated with server 106 to the selected first intelligent apparatus 102. In the signal flow P5, the host unit 100 sends a updating instruction corresponding to rapid update device mechanism to the selected first intelligent apparatus 102. In the signal flow P6, the selected first intelligent apparatus 102 logs in the server 106 and sends a download request to the server 106 based on the connection configuration information. In the signal flow P7, the selected first intelligent apparatus 102 downloads the updating program based on updating instruction from the server 106. In the signal flow P8, the selected first intelligent apparatus 102 returns a updating complete message to the host unit 100.

When the rapid update device mechanism is performed and the first intelligent apparatus 102 finds the SSID, the host unit 100 advantageously transmits the connection configuration information and the updating instruction to first intelligent apparatus 102 so that first intelligent apparatuses 102 download the updating programs from the server 106 and return the updating complete message conveniently and rapidly.

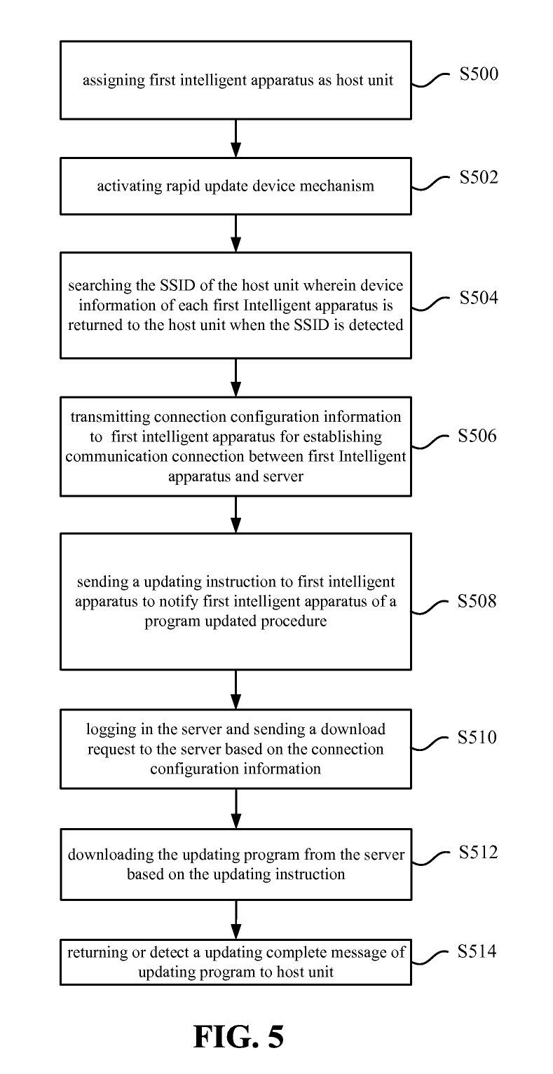

Referring to FIG. 1 and FIG. 5, FIG. 5 is a schematic flow chart of synchronously updating the programs of the intelligent apparatuses by way of the updating system according to the first embodiment of the present invention. The method comprises the following steps.

In step S500, a mobile device 108 assigns one of the first intelligent apparatuses 102 as the host unit 100. In other words, one of the first intelligent apparatuses 102 or initialized one of first intelligent apparatuses 102 is assigned as the second intelligent apparatus 103 of the host unit 100 wherein first intelligent apparatuses 102 and second intelligent apparatus 103 are the same type or different types of intelligent apparatuses.

In step S502, the host unit 100 activates a rapid update device mechanism wherein the rapid update device mechanism comprises a service set identifier (SSID).

In step S504, a plurality of first intelligent apparatuses 102 searches the SSID of the host unit 100 wherein device information of each first intelligent apparatus 102 is returned to the host unit 100 when each first intelligent apparatus 102 detects the SSID.

In step S506, the host unit 100 transmits a connection configuration information to at least one first intelligent apparatus 102 for establishing communication connection between the at least one first intelligent apparatus 102 and the server 106 wherein at least one updating program is stored in the server 106. The server 106 stores at least one updating program in the database 107 wherein the at least one updating program is selected from one group consisting of updating parameters, software, application programs, drivers and the combination thereof. The connection configuration information comprises the related information of server 106 and updating programs.

In step S508, the host unit 100 sends a updating instruction to the at least one first intelligent apparatus 102 to notify the at least one first intelligent apparatus 102 of a program updated procedure wherein the updating instruction is corresponding to updating program.

In step S510, at least one first intelligent apparatus 102 logs in the server 106 and sends a download request to the server 106 based on the connection configuration information.

In step S512, the at least one first intelligent apparatus 102 downloads the updating program from the server 106 based on the updating instruction of the host unit 102.

In step S514, the at least one first intelligent apparatus 102 returns a updating complete message of the at least one updating program to host unit 100.

When the rapid update device mechanism is performed and the first intelligent apparatus 102 finds the SSID, the host unit 100 advantageously transmits the connection configuration information and the updating instruction to first intelligent apparatus 102 so that first intelligent apparatuses 102 download the updating programs from the server 106 and return the updating complete message. According to the aforementioned descriptions, the method for synchronously updating the programs of intelligent apparatuses employs a host unit 100 to manipulate a plurality of first intelligent apparatuses 102 to download the updating programs from the server 106 for updating the programs of the first intelligent apparatuses 102 to synchronously implement program updating procedure for simplifying the program configuration of the intelligent apparatuses 102 and improve the manufacturing efficiency of the intelligent apparatuses 102.

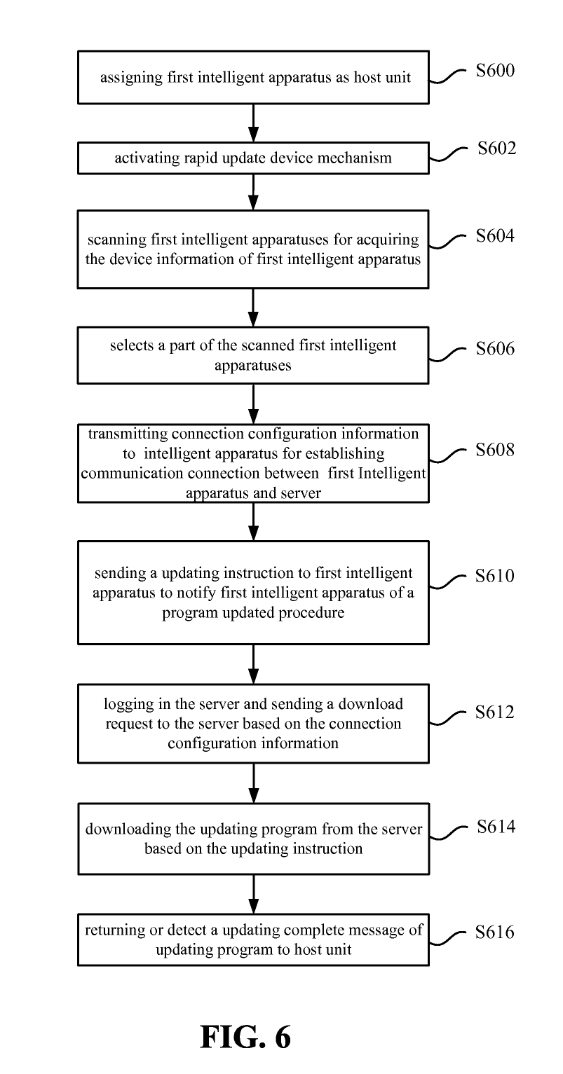

Referring to FIG. 1 and FIG. 6, FIG. 6 is a schematic flow chart of synchronously updating the programs of the intelligent apparatuses by way of the updating system according to the second embodiment of the present invention. The method comprises the following steps.

In step S600, a mobile device 108 assigns one of the first intelligent apparatuses 102 as the host unit 100. In other words, one of the first intelligent apparatuses 102 or initialized one of first intelligent apparatuses 102 is assigned as the second intelligent apparatus 103 of the host unit 100 wherein first intelligent apparatuses 102 and second intelligent apparatus 103 are the same type or different types of intelligent apparatuses.

In step S602, the host unit 100 activates a rapid update device mechanism wherein the rapid update device mechanism comprises a service set identifier (SSID).

In step S604, the host unit 100 scans the first intelligent apparatuses 102 for acquiring the device information of the at least one first intelligent apparatus 102.

In step S606, the host unit 100 selects a part of the scanned first intelligent apparatuses 102.

In step S608, the host unit 100 transmits a connection configuration information to at least one first intelligent apparatus 102 for establishing communication connection between at least one first intelligent apparatus 102 and server 106 wherein at least one updating program is stored in the server 106.

In step S610, the host unit 100 sends a updating instruction to the at least one first intelligent apparatus 102 to notify the at least one first intelligent apparatus 102 of a program updated procedure.

In step S612, at least one first intelligent apparatus 102 logs in the server 106 and sends a download request to the server 106 based on the connection configuration information.

In step S614, the at least one first intelligent apparatus 102 downloads the updating program from the server 106 based on the updating instruction of the host unit 102.

In step S616, the at least one first intelligent apparatus 102 returns a updating complete message of the at least one updating program to host unit 100. In another embodiment, the host unit 100 detects a updating complete message of the at least one updating program wherein the at least one first intelligent apparatus 102 broadcasts the updating complete message initially.

When the rapid update device mechanism is performed and the first intelligent apparatus 102 finds the SSID, the host unit 100 advantageously transmits the connection configuration information and the updating instruction to first intelligent apparatus 102 so that first intelligent apparatuses 102 download the updating programs from the server 106 and return the updating complete message. According to the aforementioned descriptions, the method for synchronously updating the programs of intelligent apparatuses employs a host unit 100 to manipulate a plurality of first intelligent apparatuses 102 to download the updating programs from the server 106 for updating the programs of the first intelligent apparatuses 102 to synchronously implement program updating procedure for simplifying the program configuration of the intelligent apparatuses 102 and improve the manufacturing efficiency of the intelligent apparatuses 102.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method for synchronously updating the programs of a plurality of intelligent apparatuses, comprising the steps of:
activating a rapid update device mechanism by way of a host unit wherein the rapid update device mechanism comprises a service set identifier (SSID);
searching the SSID of the host unit by way of a plurality of first intelligent apparatuses wherein device information of each first intelligent apparatus is returned to the host unit when each first intelligent apparatus detects the SSID;
transmitting a connection configuration information to at least one first intelligent apparatus by way of the host unit for establishing communication connection between the at least one first intelligent apparatus and the server wherein at least one updating program is stored in the server;
sending a updating instruction to the at least one first intelligent apparatus to notify the at least one first intelligent apparatus of a program updated procedure by way of the host unit; and
downloading the updating program from the server based on the updating instruction of the host unit by way of the at least one first intelligent apparatus.

2. The method for synchronously updating the programs of the intelligent apparatuses of claim 1, wherein the connection configuration information is compatible to Wireless Fidelity (Wi-Fi) protocol which is established by a wireless network access point or a router.

3. The method for synchronously updating the programs of the intelligent apparatuses of claim 1, before the step of activating the rapid update device mechanism by way of the host unit, further comprising a step of assigning one of the first intelligent apparatuses as the host unit by way of a mobile device.

4. The method for synchronously updating the programs of the intelligent apparatuses of claim 1, after the step of sending the updating instruction to the at least one first intelligent apparatus to notify the at least one first intelligent apparatus of the program updated procedure by way of the host unit, further comprising a step of logging in the server and sending a download request to the server based on the connection configuration information by way of the at least one first intelligent apparatus.

5. The method for synchronously updating the programs of the intelligent apparatuses of claim 1, after the step of downloading the updating program from the server based on the updating instruction of the host unit, further comprising a step of returning a updating complete message of the at least one updating program to host unit by way of the at least one first intelligent apparatus.

6. The method for synchronously updating the programs of the intelligent apparatuses of claim 1, after the step of downloading the updating program from the server based on the updating instruction of the host unit, further comprising a step of detecting a updating complete message of the at least one updating program by way of the host unit wherein the at least one first intelligent apparatus broadcasts the updating complete message initially.

7. The method for synchronously updating the programs of the intelligent apparatuses of claim 1, after the step of activating the rapid update device mechanism by way of the host unit, further comprising a step of scanning the first intelligent apparatuses for acquiring the device information of the at least one first intelligent apparatus by way of the host unit.

8. The method for synchronously updating the programs of the intelligent apparatuses of claim 7, wherein the host unit selects a part of the scanned first intelligent apparatuses.

9. The method for synchronously updating the programs of the intelligent apparatuses of claim 8, after the step of sending the updating instruction to the at least one first intelligent apparatus to notify the at least one first intelligent apparatus of the program updated procedure by way of the host unit, further comprising a step of logging in the server and sending a download request to the server based on the connection configuration information by way of the part of the scanned first intelligent apparatuses.

10. The method for synchronously updating the programs of the intelligent apparatuses of claim 8, after the step of downloading the updating program from the server based on the updating instruction of the host unit, further comprising a step of returning a updating complete message of the at least one updating program to the host unit by way of the part of the scanned first intelligent apparatuses.

11. The method for synchronously updating the programs of the intelligent apparatuses of claim 8, after the step of downloading the updating program from the server based on the updating instruction of the host unit, further comprising a step of detecting a plurality of updating complete messages of the at least one updating program by way of the host unit wherein the part of the scanned first intelligent apparatuses broadcast the updating complete messages initially.

12. A system for synchronously updating the programs of a plurality of intelligent apparatuses, comprising:
a host unit, for activating a rapid update device mechanism wherein the rapid update device mechanism comprises a service set identifier (SSID);
a plurality of first intelligent apparatuses, for searching the SSID of the host unit wherein device information of each first intelligent apparatus is returned to the host unit when each first intelligent apparatus detects the SSID, and the host unit transmits a connection configuration information to at least one first intelligent apparatus; and
a server, for storing at least one updating program wherein the host unit establishes a communication connection between the at least one first intelligent apparatus and the server;
wherein the host unit sends a updating instruction to the at least one first intelligent apparatus to notify the at least one first intelligent apparatus of a program updated procedure, and the at least one first intelligent apparatus downloads the updating program from the server based on the updating instruction of the host unit.

13. The system for synchronously updating the programs of the intelligent apparatuses of claim 12, wherein the connection configuration information is compatible to Wireless Fidelity (Wi-Fi) protocol which is established by a wireless network access point or a router.

14. The system for synchronously updating the programs of the intelligent apparatuses of claim 12, wherein the host unit is a transmitter with a wireless network function for sending the connection configuration information.

15. The system for synchronously updating the programs of the intelligent apparatuses of claim 12, wherein the host unit is one selected from the first intelligent apparatuses and the selected first intelligent apparatus is initialized to be served as a second intelligent apparatus for transferring the connection configuration information.

16. The system for synchronously updating the programs of the intelligent apparatuses of claim 12, wherein the system further comprises a mobile device for assigning one of the first intelligent apparatuses as the host unit.

17. The system for synchronously updating the programs of the intelligent apparatuses of claim 12, wherein the at least one first intelligent apparatus logs in the server and sends a download request to the server based on the connection configuration information.

18. The system for synchronously updating the programs of the intelligent apparatuses of claim 12, wherein the at least one first intelligent apparatus returns a updating complete message of the at least one updating program to host unit.

19. The system for synchronously updating the programs of the intelligent apparatuses of claim 12, wherein the host unit detects a updating complete message of the at least one updating program and the at least one first intelligent apparatus broadcasts the updating complete message initially.

20. The system for synchronously updating the programs of the intelligent apparatuses of claim 12, wherein the host unit scans the first intelligent apparatuses for acquiring the device information of the at least one first intelligent apparatus.

21. The system for synchronously updating the programs of the intelligent apparatuses of claim 20, wherein the host unit selects a part of the scanned first intelligent apparatuses.

22. The system for synchronously updating the programs of the intelligent apparatuses of claim 21, wherein the part of the scanned first intelligent apparatuses log in the server and send a download request to the server based on the connection configuration information.

23. The system for synchronously updating the programs of the intelligent apparatuses of claim 21, wherein the part of the scanned first intelligent apparatuses return a updating complete message of the at least one updating program to the host unit.

24. The system for synchronously updating the programs of the intelligent apparatuses of claim 21, wherein the host unit detects a plurality of updating complete messages of the at least one updating program and the part of the scanned first intelligent apparatuses broadcast the updating complete messages initially.
